(19) United States
(12) Patent Application Publication
(10) Pub. No.: US 2025/0178342 A1
(43) Pub. Date: Jun. 5, 2025

(54) RECORDING DEVICE

(71) Applicant: CANON KABUSHIKI KAISHA, Tokyo (JP)

(72) Inventor: KAZUKI KURATA, Tokyo (JP)

(21) Appl. No.: 18/952,076

(22) Filed: Nov. 19, 2024

(30) Foreign Application Priority Data
Dec. 1, 2023 (JP) 2023-203909

(51) Int. Cl. B41J 2/045

(52) U.S. Cl. CPC B41J 2/04573; B41J 2/0455; B41J 2/04581; B41J 2/04588

(57) ABSTRACT

Provided is a recording device which includes first and second output units outputting first and second drive signals for driving a piezoelectric element, first and second switches switching on or off the input of the first and second drive signals to the piezoelectric element, a selection output unit outputting selection information indicating which of the first and second drive signals is to be input to the piezoelectric element based on image data, and a control output unit outputting a switch control signal for controlling on and off of the first and second switches based on the selection information and a timing signal, wherein the switch control signal is a control signal for turning off the first and second switches during a predetermined period including a switching timing defined by the timing signal.

### BACKGROUND OF THE INVENTION

### Field of the Invention

The present invention relates to an inkjet recording device.

### Description of the Related Art

Some inkjet recording devices are equipped with a recording head that ejects ink from a nozzle by driving a piezoelectric element, and implement recording by using the ink ejected by the recording head. In such recording devices, ink is ejected according to image data by inputting to the piezoelectric element a drive signal that is selected based on image data from among a plurality of drive signals that correspond to a plurality of drive patterns of the piezoelectric element.

Japanese Patent Application Publication No 2020-142490 describes a recording device having a recording head and a control board in which one piezoelectric element is connected via a plurality of analog switches (hereinafter referred to as switches) to a plurality of amplifiers that output respectively different drive waveforms corresponding to different droplet types (droplet sizes). In this recording device, a plurality of switches are switched ON/OFF for each ejection timing, selectively supplying each piezoelectric element with a drive waveform corresponding to the droplet type.

In such a recording device, as illustrated in FIG. 20, it is assumed that switches 1 and 2, of which ON/OFF is controlled by a switch control signal output by a decoder 509, are connected to a piezoelectric element corresponding to a certain nozzle N. Moreover, it is assumed that a drive signal 1, which corresponds to a large ink droplet size, is input to the switch 1, and a drive signal 2, which corresponds to a small ink droplet size, is input to the switch 2.

FIG. 18 illustrates an example of control signals that control the ON/OFF of each switch when continuous ejection is performed from the nozzle N, drive signals input to respective switches, and a drive signal input to a piezoelectric element of the nozzle N. An ejection timing is controlled by a latch signal. It is assumed that at a certain time point st3, the switch 1 is turned ON, the switch 2 is turned OFF, and the drive signal 1 is applied to the nozzle N.

The switches 1 and 2 switch ON/OFF when the latch signal falls, thereby switching the drive signal applied to the piezoelectric element of the nozzle N. At time t′, the latch signal falls, the switch 1 is turned OFF, and the switch 2 is turned ON. Then, a drive signal 2 is applied to the nozzle N (st4).

FIG. 19 illustrates detailed operation at the time t′. An OFF signal is input to the switch 1 at a falling timing of the latch signal, but there is generally a delay time Δt1 before the switch 1 actually enters a state of OFF completely. Also, an ON signal is input to the switch 2 at the falling timing of the latch signal, but there is generally a delay time Δt2 before the switch 2 actually enters a state of ON completely. Lengths of Δt1 and Δt2 vary depending on manufacturing variations in a semiconductor integrated circuit that makes up the switch and operating environment conditions such as temperature.

As illustrated in an example in FIG. 19, when Δt1>Δt2, there will be a period when the switch 1 and the switch 2 are simultaneously ON. Then, the circuit that outputs the drive signal 1 and the circuit that outputs the drive signal 2 are connected via the switch 1 and the switch 2. In this case, when there is a difference in voltage between the drive signal 1 and the drive signal 2 (in FIG. 19, drive signal 1 voltage>drive signal 2 voltage), a large current will flow through a route of drive signal 1 output circuit→switch 1→switch 2→drive signal 2 output circuit. This current may cause the drive signal output circuit or the switch to malfunction or fail.

Therefore, as illustrated in FIG. 20, a simultaneous ON prevention circuit 520 may be provided after the decoder 509 that outputs the switch control signal, and an OFF signal may be input to all switches for a predetermined period, regardless of the switch control signal output by the decoder 509. For example, by inputting an OFF signal to all switches during a period that includes a switching timing of the switch control signal, it is possible to prevent a plurality of analog signals from entering a state of being turned ON simultaneously. However, with this configuration, the provision of the simultaneous ON prevention circuit may complicate a circuit configuration, resulting in increased costs.

### SUMMARY OF THE INVENTION

The present invention provides a recording device that uses a piezoelectric element to eject liquid, and uses a simple configuration to prevent a plurality of analog switches that switch a drive signal to be input to the piezoelectric element from entering a state of being turned on simultaneously.

The present invention is recording device including a piezoelectric element and a recording head ejecting liquid by driving the piezoelectric element, the recording device performing recording by the liquid ejected by the recording head, the recording device comprising: a first output unit outputting a first drive signal for driving the piezoelectric element; a second output unit outputting a second drive signal for driving the piezoelectric element; a first switch switching on or off input of the first drive signal output from the first output unit to the piezoelectric element; a second switch switching on or off input of the second drive signal output from the second output unit to the piezoelectric element; a selection output unit outputting selection information indicating which of the first drive signal and the second drive signal is to be input to the piezoelectric element based on image data; and a control output unit outputting to the first switch and the second switch a switch control signal for controlling on and off of the first switch and the second switch based on the selection information input from the selection output unit and a timing signal defining a switching timing of the selection information, wherein the switch control signal output by the control output unit is a control signal for turning off the first switch and the second switch during a predetermined period including the switching timing defined by the timing signal.

Further features of the present invention will become apparent from the following description of exemplary embodiments with reference to the attached drawings.

### BRIEF DESCRIPTION OF THE DRAWINGS

FIG. 1 is an explanatory diagram of a serial-parallel conversion unit, a data latch unit, and a group of switches;

FIG. 2 is a diagram illustrating an internal circuit of a decoder;

FIG. 3 is an explanatory diagram of an operation of a latch signal and an analog switch;

FIG. 4 is a diagram illustrating an overall configuration of a recording device;

FIG. 5 is a schematic diagram illustrating a unit of a recording head;

FIG. 6 is a diagram illustrating the recording head;

FIG. 7 is a schematic diagram illustrating an example of wiring of the recording head;

FIG. 8 is a schematic diagram illustrating another example of the wiring of the recording head;

FIG. 9A is a diagram illustrating a method of driving a piezoelectric element;

FIG. 9B is a diagram illustrating a drive signal for the piezoelectric element;

FIG. 10 is a diagram illustrating a functional configuration of the recording device;

FIG. 11 is a diagram illustrating an image processing unit;

FIG. 12 is a diagram illustrating a drive signal selection unit;

FIG. 13 is a diagram illustrating serial communication 1;

FIG. 14 is a timing chart of the drive signal selection unit;

FIG. 15 is a diagram illustrating an example of an amplifier circuit that generates a signal for ink ejection;

FIG. 16 is a diagram illustrating a residual vibration voltage;

FIG. 17 is a diagram illustrating a comparative example of a residual vibration voltage detection circuit;

FIG. 18 is an explanatory diagram of an operation when ink is continuously ejected;

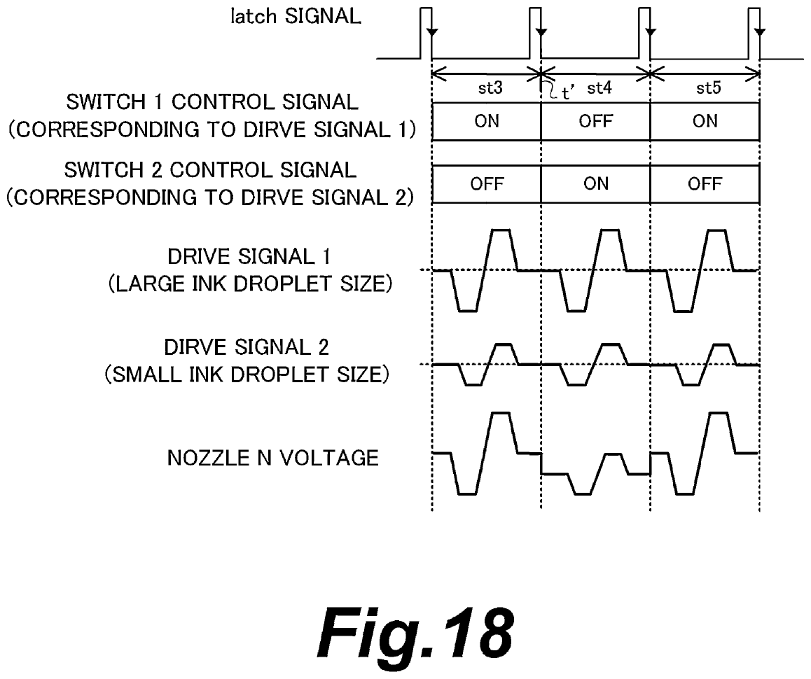

FIG. 19 is a detailed explanatory diagram of the operation when ink is continuously ejected; and

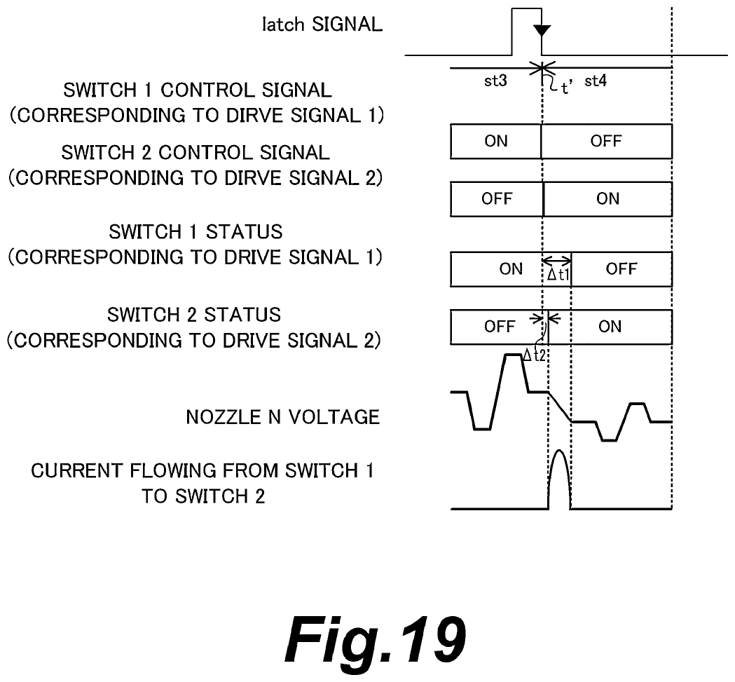

FIG. 20 is an explanatory diagram of a simultaneous ON prevention circuit, a comparative example.

### DESCRIPTION OF THE EMBODIMENTS

Illustrative forms for carrying out the present invention will be described below with reference to the drawings. However, dimensions, materials, shapes, and relative arrangements of the components described in following embodiment should be modified as appropriate depending on configuration and various conditions of a device to which the present invention is applied, and are not intended to limit the scope of the present invention to the following embodiment.

### Overall Configuration of Recording Device

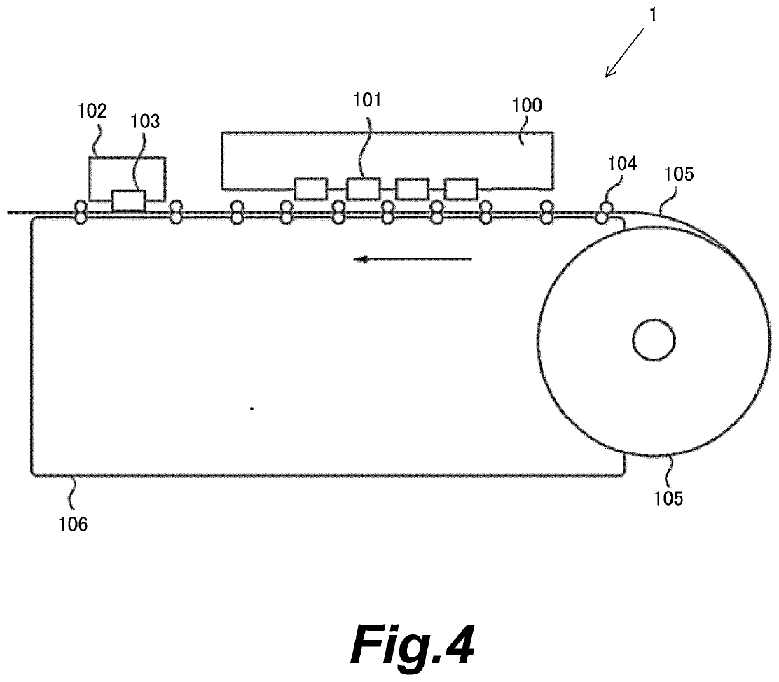

FIG. 4 is a side cross-sectional view illustrating a configuration of a recording device 1 that uses a full-line inkjet recording head to record on a roll-shaped recording medium such as roll paper, as an example of an inkjet recording device. A full-line inkjet recording head (hereinafter referred to as a “recording head”) is a recording head with a recording width equal to or greater than a width of the roll paper. As illustrated in FIG. 4, this recording device 1 generally includes a housing 106, a head unit 100, first to fourth recording heads 101 corresponding to, for example, four colors CMYK, a scanner unit 102, a line scanner 103, and a transport roller 104. Then, roll paper 105 used as the recording medium is nipped by the pair of transport rollers 104 and transported in a direction of the arrow, and is sequentially subject to recording directly under each of the first to fourth recording heads 101.

### Configuration of Recording Head

A known method for ejecting ink from nozzles in the recording head 101 is to generate pressure in a pressure chamber using a piezoelectric element as an ejection energy generating element, and eject the liquid in the pressure chamber from a nozzle formed at one end of the pressure chamber using that pressure. The recording device 1 records using ink ejected from the nozzles of the recording head 101. In such a recording head 101, each piezoelectric element has an electrical contact and is connected to an integrated circuit that generates a drive signal, and ejection is performed by driving the piezoelectric element with the drive signal.

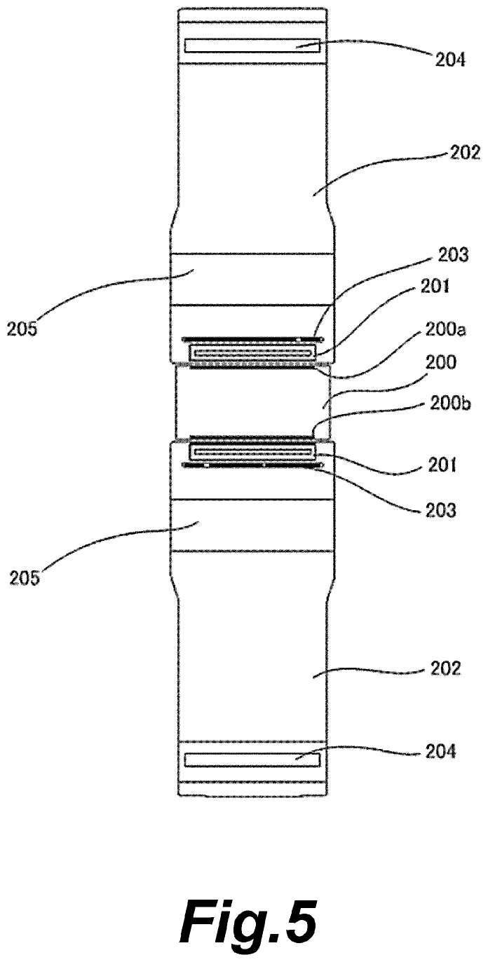

FIG. 5 is a schematic diagram of a unit 209 combining a piezoelectric element substrate 200, a drive element selection unit 201, and a flexible electrical wiring substrate 202. The piezoelectric element substrate 200 has a first terminal 200a and a second terminal 200b, which are respectively electrically connected to terminals (not illustrated) provided on the drive element selection units 201 mounted on the flexible electrical wiring substrates 202. The flexible electrical wiring substrate 202 has a selection unit side terminal 203, which is electrically connected to a wiring substrate side terminal (not illustrated) provided on the drive element selection unit 201.

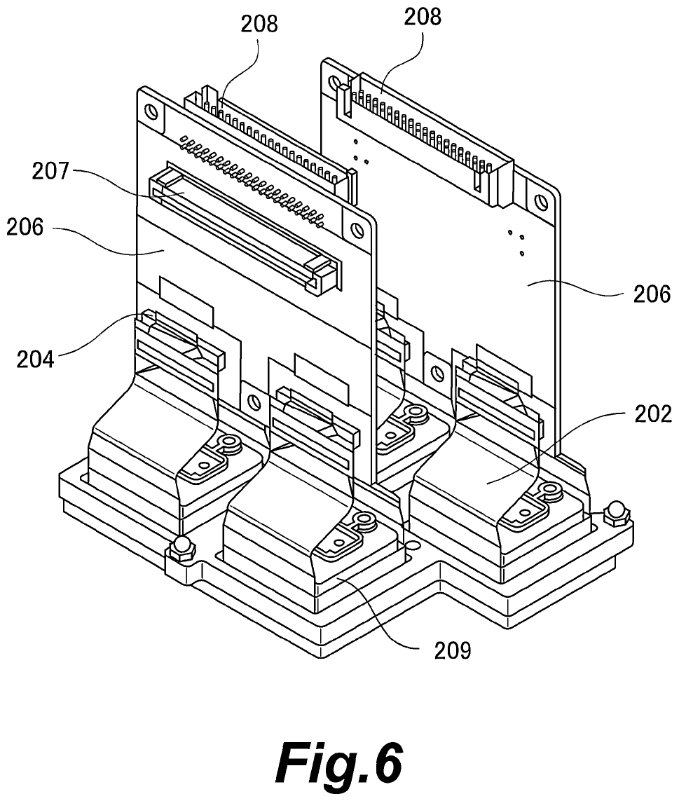

The flexible electrical wiring substrate 202 includes a capacitor area 205 for mounting a power supply bypass capacitor for the drive element selection unit 201, and a head substrate connection unit 204 for connecting to a head substrate (not illustrated). FIG. 6 is a schematic diagram of the recording head 101. One recording head 101 is composed of four units 209. Each unit 209 is electrically connected to a head substrate 206 by the head substrate connection unit 204. The head substrate 206 has a signal connection unit 207 and a drive signal connection unit 208 that are connected to a main body of the recording device 1.

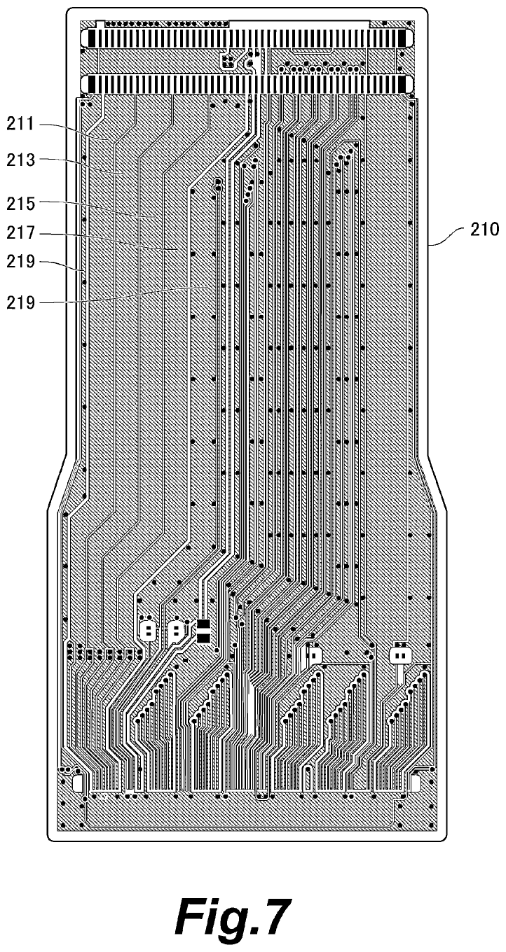

FIG. 7 illustrates wiring of a first layer of the flexible electrical wiring substrate 210. A first drive signal wiring 211, a third drive signal wiring 213, a fifth drive signal wiring 215, and a seventh drive signal wiring 217 all have approximately the same wiring width. Drive signal return current lines 219 are respectively arranged on a side of the first drive signal wiring 211 opposite the third drive signal wiring 213, and on a side of the seventh drive signal wiring 217 opposite the fifth drive signal wiring 215.

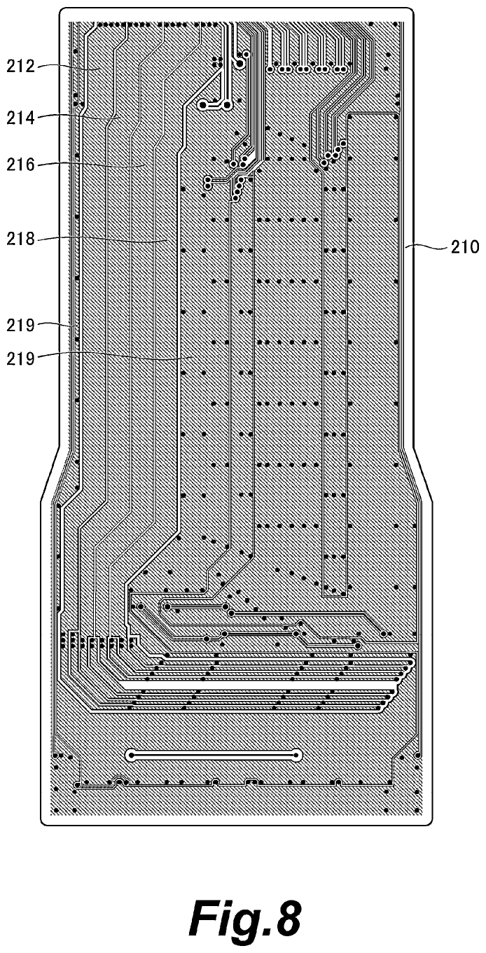

FIG. 8 illustrates wiring of a second layer of the flexible electrical wiring substrate 210. A second drive signal wiring 212, a fourth drive signal wiring 214, a sixth drive signal wiring 216, and an eighth drive signal wiring 218 all have approximately the same wiring width. Drive signal return current lines 219 are respectively arranged on a side of the second drive signal wiring 212 opposite the fourth drive signal wiring 214, and on a side of the eighth drive signal wiring 218 opposite the sixth drive signal wiring 216.

Description of Piezoelectric Element Drive Method and Piezoelectric Element Drive Signal

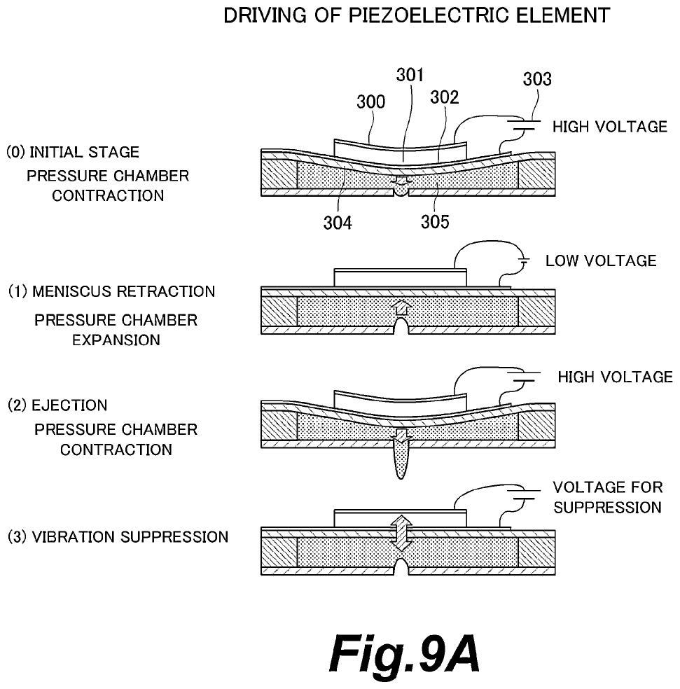

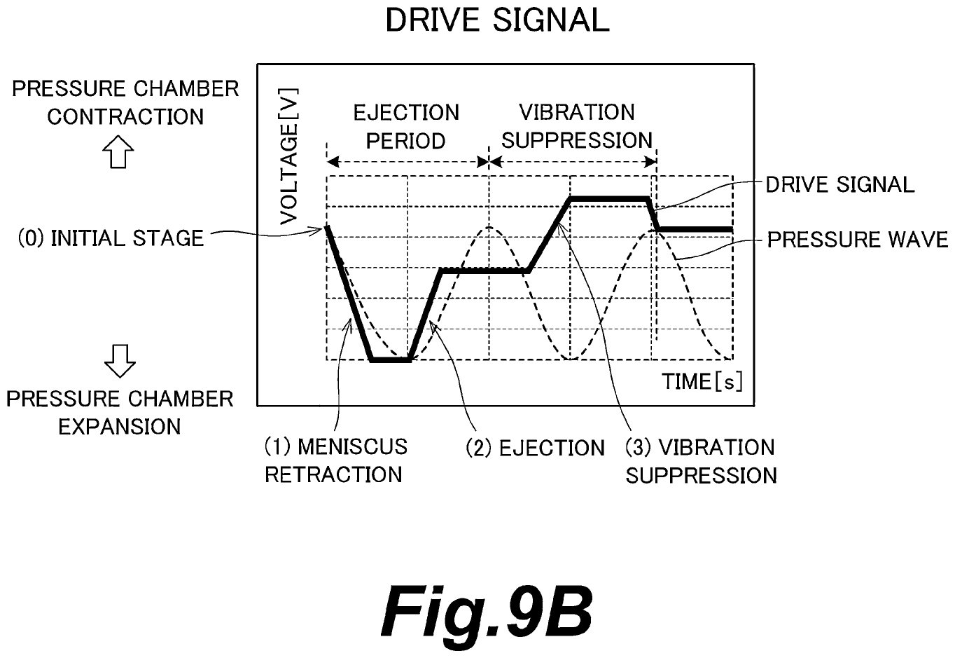

A method of driving a piezoelectric element 301 and a drive signal applied to the piezoelectric element 301 will be described using FIGS. 9A and 9B. Driving the piezoelectric element 301 involves steps (0) to (3) as illustrated in FIG. 9A, and applied voltage (drive signal) changes in these steps as illustrated in FIG. 9B. These will be described in order.

(0) In an initial state, a pressure chamber 304 is filled with ink 305, and a high voltage is applied between an upper electrode 300 and a lower electrode 302 of the piezoelectric element 301 from a voltage source 303, causing the pressure chamber 304 to contract. (1) The voltage of the voltage source 303 is lowered to expand the pressure chamber 304 and draw in the ink 305. In this case, a sinusoidal pressure wave is generated in the pressure chamber 304 by the piezoelectric element 301. (2) The voltage of the voltage source 303 is increased in synchronization with the pressure wave generated in (1) above, causing the pressure chamber 304 to contract and eject the ink 305. (3) After (2) above, the piezoelectric element 301 continues to vibrate mechanically. To cancel this mechanical vibration and stop the piezoelectric element 301, the voltage of the voltage source 303 is increased again.

One ejection operation is performed through the above steps (0) to (3), and the series of voltage changes of the voltage source 303 described above is the waveform of the drive signal to be applied to the piezoelectric element 301.

### Functional Configuration of Recording Device

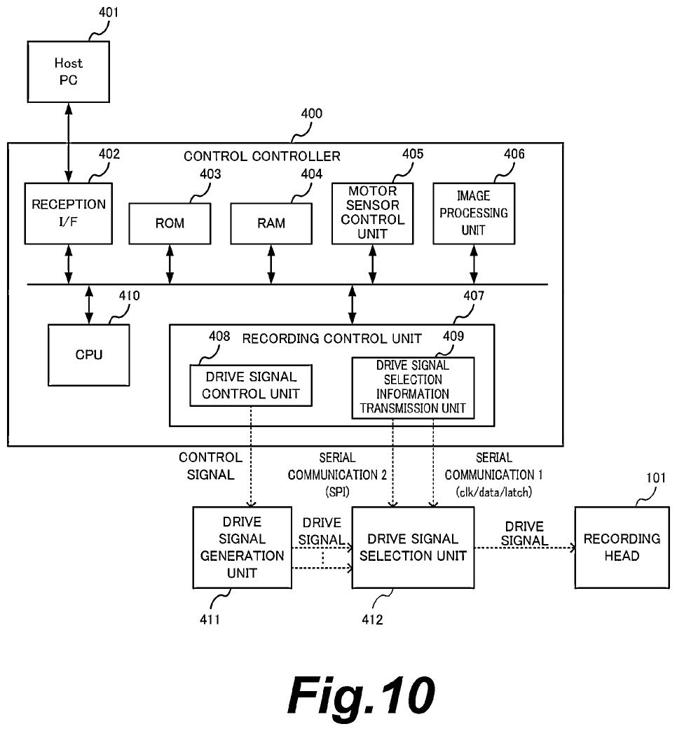

A functional configuration of the recording device 1 will be described. FIG. 10 is a block diagram illustrating the functional configuration of the recording device 1. A Host PC 401 transmits print instructions and print data to a control controller 400. The control controller 400 that controls the recording device 1 has a reception I/F 402 that communicates with the Host PC 401, a CPU 410, and a ROM 403 that stores programs that operate the CPU 410. The control controller 400 also has a RAM 404 that executes programs and temporarily stores various data, and a motor sensor control unit 405 that controls the motor sensor in the recording device 1. The control controller 400 also has an image processing unit 406 that performs image processing on the print data sent from the Host PC 401 through the reception I/F 402, and a recording control unit 407 that controls the recording head 101 based on the data processed by the image processing unit 406.

The image processing unit 406 generates raster image data that can be printed using the print data received from the Host PC 401, and converts it into image data for each ink color such as CMYK that can be processed by the recording control unit 407 and outputs it. The recording control unit 407 consists of a drive signal control unit 408 and a drive signal selection information transmission unit 409. The drive signal control unit 408 transmits a control signal for generating a drive signal to a drive signal generation unit 411. The drive signal selection information transmission unit 409 transmits drive signal selection information to a drive signal selection unit 412 via serial communication 1.

The drive signal generation unit 411 outputs a plurality of drive signals to the drive signal selection unit 412 based on the control signal transmitted from the drive signal control unit 408. The drive signal selection unit 412 selects a drive signal for driving a nozzle from the plurality of drive signals input from the drive signal generation unit 411 based on the drive signal selection information transmitted from the drive signal selection information transmission unit 409. Then, the drive signal selection unit 412 inputs the drive signal to the piezoelectric element 301 corresponding to the nozzle in the head unit 100. When the voltage of the drive signal waveform is applied to the electrodes of the piezoelectric element 301, the piezoelectric element 301 between the electrodes is displaced, and the resulting ejection energy is used to eject ink from the nozzle.

The serial communication 1 between the drive signal selection information transmission unit 409 and the drive signal selection unit 412 is composed of a clock signal (clk), a data signal (data), and a latch signal (latch). Information is transmitted on a data signal in synchronization with the clock signal, and information is transmitted in units of latch signals.

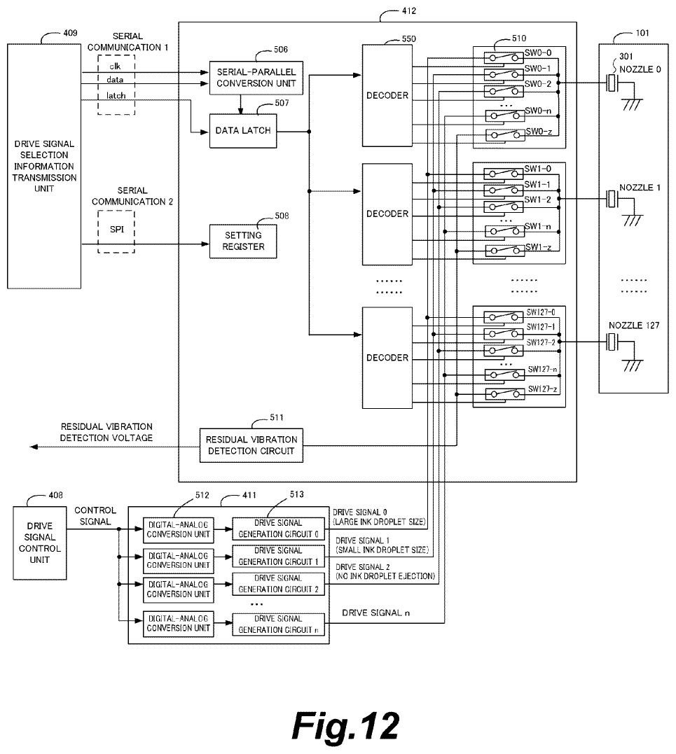

Serial communication 2 between the drive signal selection information transmission unit 409 and the drive signal selection unit 412 is used to set various setting information for the operation of the drive signal selection unit 412 with respect to a setting register 508 (see FIG. 12) inside the drive signal selection unit 412. A widely known communication protocol such as Serial Peripheral Interface (SPI) is used, but the communication method is not limited to this.

The recording head 101 is composed of nozzles with a mechanism for ejecting ink and the piezoelectric elements 301 corresponding to the nozzles, and ejects ink by inputting drive signals to the piezoelectric elements 301 corresponding to the nozzles. Here, the recording head 101 is assumed to be composed of 128 nozzles and the piezoelectric elements 301 corresponding to the nozzles. The number of nozzles is one example and is not limited to this.

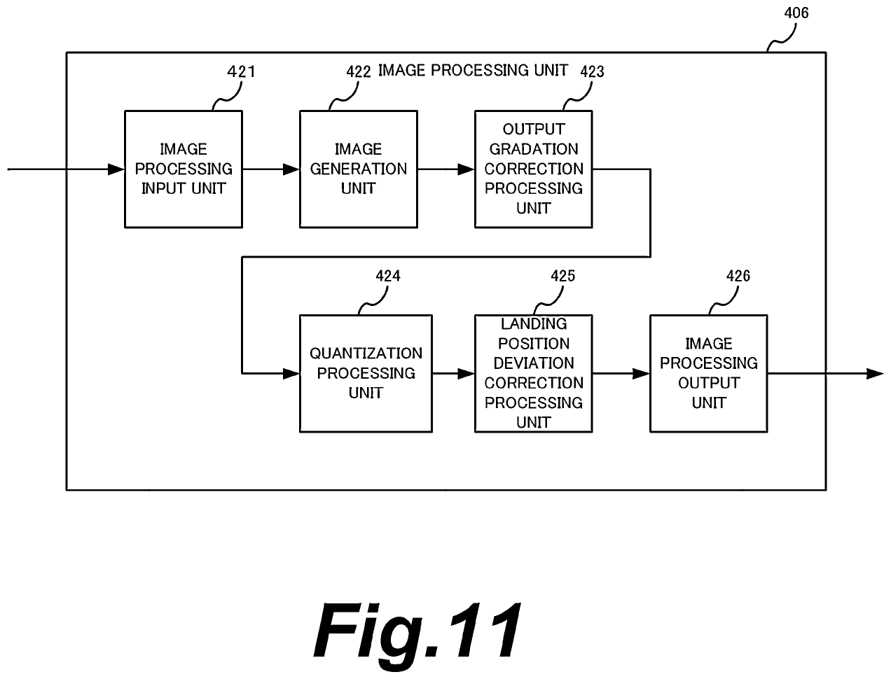

FIG. 11 is a diagram illustrating details of the processing content of the image processing unit 406 in FIG. 10. An image processing input unit 421 takes in print data and outputs it to an image generation unit 422. The image generation unit 422 uses the print data to convert it into CMYK data of a resolution recordable by the recording head 101 and outputs it. An output gradation correction processing unit 423 performs correction processing corresponding to the output characteristics of the ink.

A quantization processing unit 424 performs processing to convert 8-bit to 16-bit gradation data into gradations that can be expressed by the nozzles of the recording head 101. Typically, error diffusion or dithering is used to convert the data to N-value data, and the gradation is converted to 1-bit to 4-bit image data. A landing position deviation correction processing unit 425 shifts the data on a pixel basis to correct the landing position deviation for each nozzle in image resolution units. An image processing output unit 426 performs processing to output results of image processing.

### Description of Drive Signal Selection Unit

The drive signal selection unit 412 will be described using FIG. 12. Data transmitted from the drive signal selection information transmission unit 409 via the serial communication 1 (clk/data/latch) is received by a serial-parallel conversion unit 506 and held in a data latch 507, starting from the input timing of the latch signal. The held drive signal selection information is input to a decoder 550.

In addition, the drive signal generation unit 411 is also composed of a plurality of digital-analog conversion units 512 and a plurality of drive signal generation circuits 513. The digital-analog conversion units 512 receive control signals from the drive signal control unit 408. The drive signal generation circuit 513 receives the output analog signal from the digital-analog conversion unit and generates a drive signal.

The generated drive signal is input to a switch group 510 in the drive signal selection unit 412 mounted on the flexible electrical wiring substrate 202 through the head substrate 206 and the flexible electrical wiring substrate 202. The switch group 510 is composed of a plurality of analog switches SWx-y (x corresponds to the nozzle number and y corresponds to the drive signal number; hereafter referred to as switches), and selects a drive signal from a plurality of drive signals based on the decode information (switch control signal) of the decoder 550 to drive the piezoelectric element 301 corresponding to the nozzle.

The drive signal generation unit 411 is a generation unit that generates a plurality of drive signals corresponding to a plurality of drive patterns of the piezoelectric element 301. The plurality of drive patterns are, for example, large ink droplet size, small ink droplet size, no ink droplet ejection, and the like. The drive signal selection information transmission unit 409 is a designation unit that designates a drive signal for driving the piezoelectric element 301 from the plurality of drive signals generated by the drive signal generation unit 411. The drive signal selection unit 412 is a switch unit that outputs to the piezoelectric element 301 the drive signal designated by the drive signal selection information transmission unit 409 from the plurality of input drive signals.

The recording head 101 is, for example, made up of 128 nozzles and a piezoelectric element 301 corresponding to each nozzle, and there are as many decoders 550 and switch groups 510 as there are nozzles.

### Description of Serial Communication 1

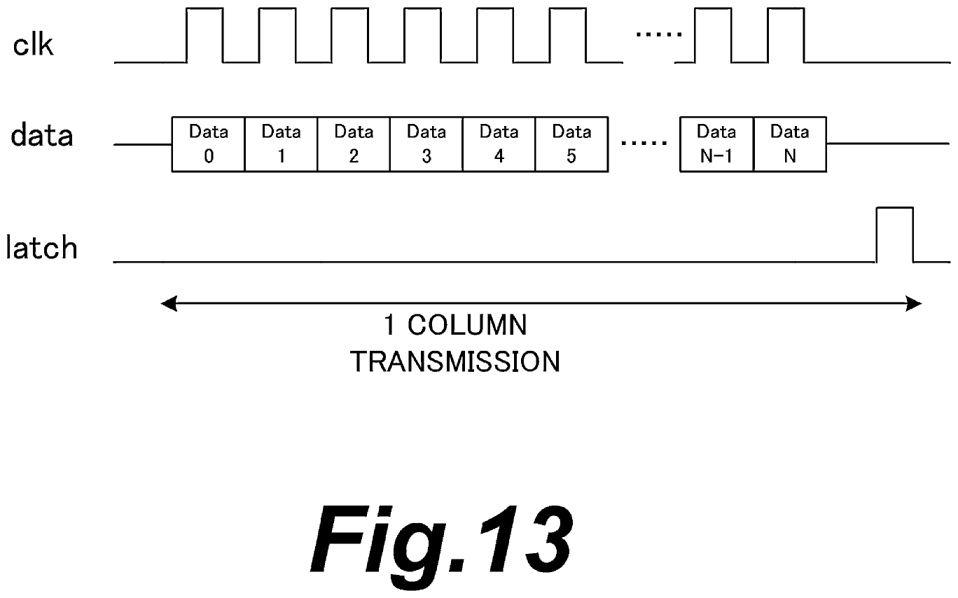

FIG. 13 illustrates contents of the serial communication 1 output from the drive signal selection information transmission unit 409. The data signal is transmitted in synchronization with the clock signal, and the latch signal indicates the end of one transmission.

The data signal does not need to be one line and the number of the data signals can be increased in balance with the clock signal frequency to keep up with the ink ejection frequency. Here, communication is performed so that data for one column, that is, data for the number of nozzles x drive signal selection information, can be transmitted between latch signals. For example, when there are four types of drive signals and the number of nozzles is 128, 128×2 bits (4 selections) of data will be transmitted. When there is a residual vibration detection switch, described below, there are 4 types+1 residual vibration detection=5 states, so 128×3 bits (5 selections) of data will be transmitted.

### Drive Signal Selection Unit Timing Chart

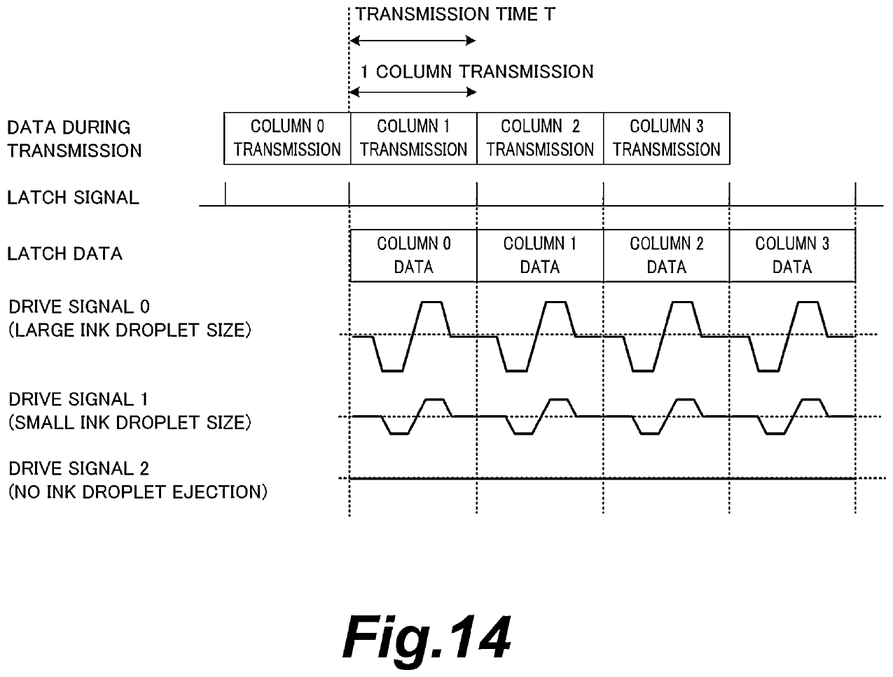

FIG. 14 illustrates a relationship between the data of the serial communication 1 and the drive signals. Drive signal selection information for one column (for all nozzles) is sent between latch signals, and the received data is stored in the data latch 507 in FIG. 12, starting from the latch signal. Based on the stored data, the four input drive signals are selected for each nozzle and applied to the piezoelectric element 301 corresponding to the nozzle. Drive signals that can achieve the desired ink droplet states, such as large ink droplet size, small ink droplet size, or no ink droplet ejection, are assigned to the four drive signal generation circuits 513.

### Description of Drive Signal Generation Circuit

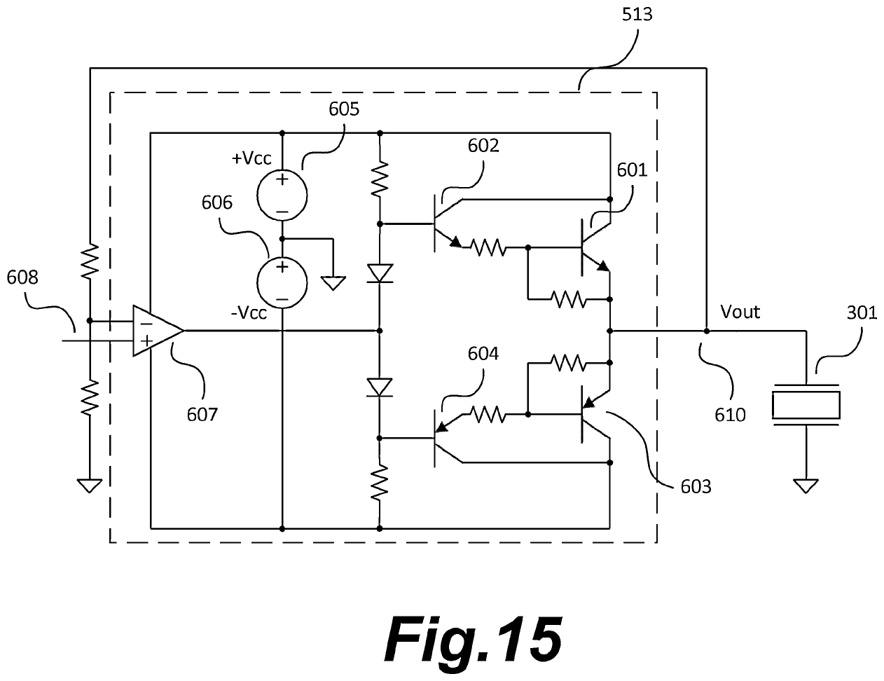

FIG. 15 is a diagram illustrating the drive signal generation circuit 513 that generates a drive signal. The drive signal generation circuit 513 is a so-called amplifier circuit, and amplifies the voltage and current of an analog signal 608 supplied to a non-inverting input terminal of an operational amplifier 607.

The drive signal generation circuit 513 is composed of transistors 601 and 602 connected in a Darlington configuration on the high side, transistors 603 and 604 connected in a Darlington configuration on the low side, and the operational amplifier 607. The transistors 601 and 602 are npn transistors, and the transistors 603 and 604 are pnp transistors. Base terminals of the transistors 602 and 604 are connected to an output terminal of the operational amplifier 607 via diodes, and emitter terminals of the transistors 601 and 603 are connected to the piezoelectric element 301 via switches SWx-n (not illustrated). Reference symbols 605 and 606 indicate power supply voltages.

In the above configuration, when the analog signal 608 is input to the drive signal generation circuit 513, the voltage of the analog signal 608 is amplified in the operational amplifier 607. Next, the current is amplified by the transistors 601 and 602 and the transistors 603 and 604. The piezoelectric element 301 is driven by a drive signal 610, the voltage and current of which have been amplified, causing ink to be ejected.

### Description of Residual Vibration Detection Circuit

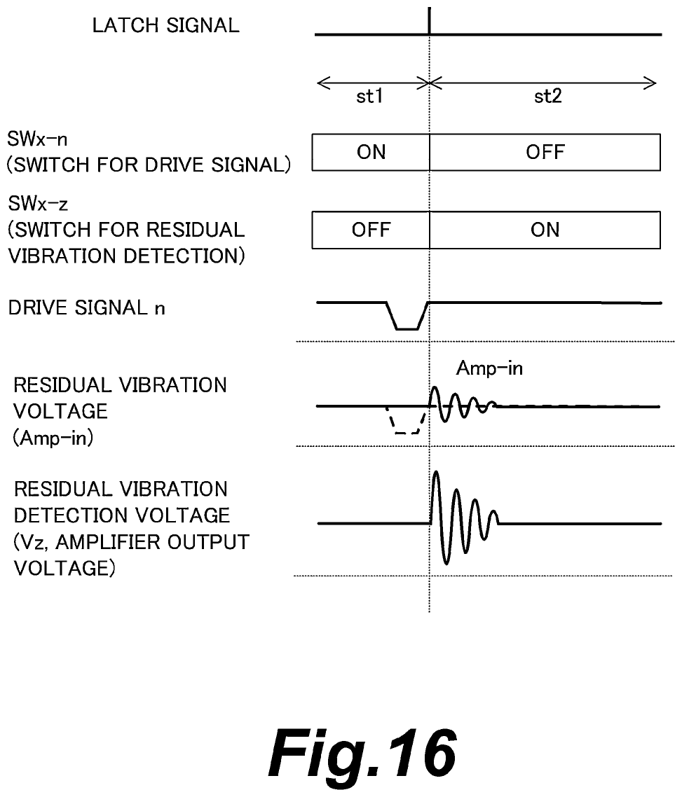

Of the switches SWx-y included in the switch group 510 in FIG. 12, switches SWx-0 to SWx-n are switches for applying a drive signal to the piezoelectric element 301 corresponding to the nozzle. On the other hand, switches SWx-z are switches for supplying the residual vibration voltages generated in the piezoelectric elements 301 due to the residual vibration after the piezoelectric elements 301 are driven to the residual vibration detection circuits 511. The residual vibration detection circuit 511 is a detection unit that detects the residual vibration voltage caused by the residual vibration generated in the piezoelectric element 301 after the piezoelectric element 301 is driven by a designated drive signal. The residual vibration detection circuit 511 has an amplifier unit that amplifies and outputs the detected residual vibration voltage. As illustrated in FIG. 16, a drive signal is applied to the piezoelectric element 301, driving the piezoelectric element 301 (st1 section). Then, the piezoelectric element 301 is disconnected from the drive signal. A vibration voltage like Amp-in in FIG. 16 then appears in the piezoelectric element 301. This is called a residual vibration voltage, which is the mechanical vibration remaining in the piezoelectric element 301 converted into voltage by the piezoelectric effect (st2 section). Anomalies in each nozzle can be detected by detecting and analyzing the residual vibration voltage.

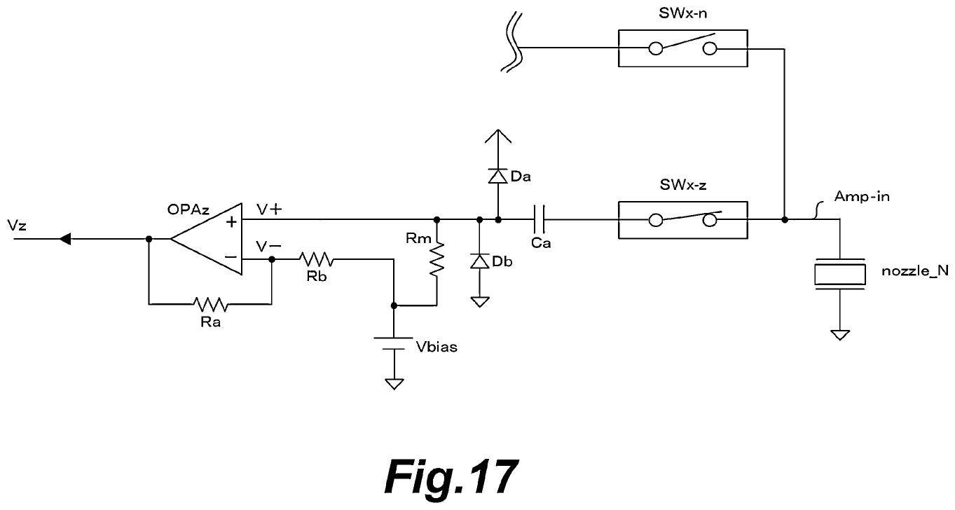

Details of the residual vibration detection circuit 511 are described in FIG. 17. In FIG. 17, the residual vibration voltage Amp-in is supplied to a non-inverting input terminal V+ of an operational amplifier OPAz via a switch SWx-z and a capacitor Ca. The V+ terminal of OPAz is also connected to a bias voltage Vbias via a resistor Rm. On the other hand, an inverting input terminal V− of OPAz is connected to a Vbias via a resistor Rb. Furthermore, the inverting input terminal V− of OPAz is connected to an output terminal of the operational amplifier OPAz via a resistor Ra.

In the above circuit, the residual vibration voltage Amp-in is amplified to become a residual vibration detection voltage Vz. The residual vibration detection voltage Vz is expressed by Equation. (1).

$$[ Math 1 ]$$

$${V}_{Z} = \frac{{R}_{a} + {R}_{b}}{{R}_{b}} \cdot {Amp}_{- in} + {V}_{bias} \qquad Expression ( 1 )$$

The residual vibration detection voltage Vz is sent to the outside of the residual vibration detection circuit 511. The residual vibration detection voltage Vz is then converted into a digital signal by an analog-digital conversion device and analyzed by a logical operation element (not illustrated).

The decoder 550 of this embodiment will be described in detail below. An EN signal input unit is provided in the decoder 550. An EN signal is a signal that controls the output of the decoder 550, and in this embodiment, the decoder 550 is configured so that when the EN signal input to the EN signal input unit is at an H level, all output signals of the decoder 550 are at an L level. The H level of the signal level corresponds to a logical value of 1, and the L level of the signal level corresponds to a logical value of 0. By inputting a latch signal as an EN signal to the EN signal input unit, when the latch signal is at the H level, all output signals are at the L level, and all switches SWm-0 to SWm-z connected in the subsequent stages are turned OFF. This prevents the switches from being turned ON simultaneously.

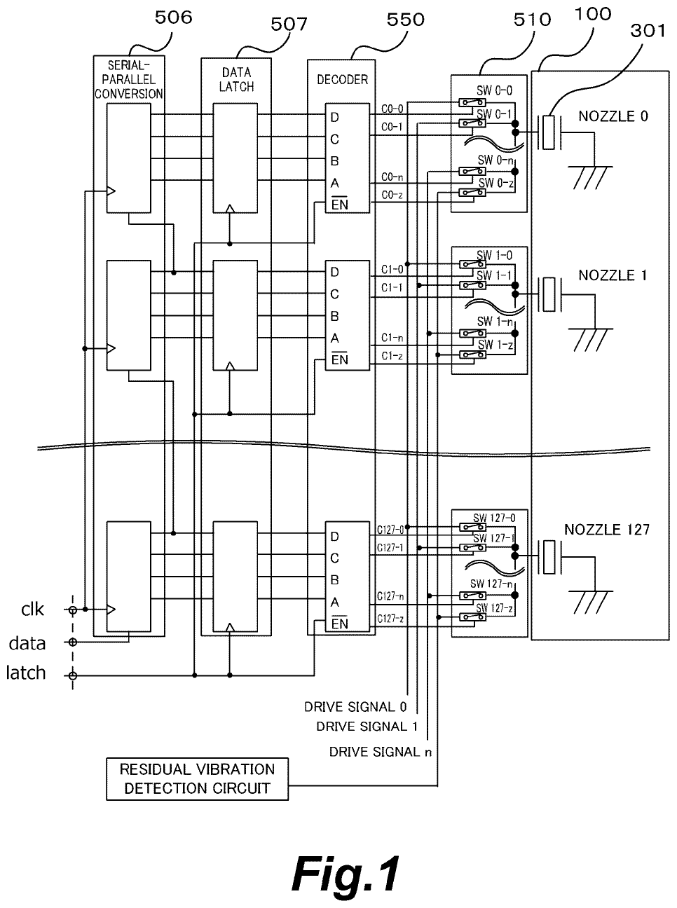

FIG. 1 illustrates the decoder 550, the serial-parallel conversion unit 506, the data latch 507, and the switch group 510 according to this embodiment. The serial-parallel conversion unit 506 converts the drive signal selection information from a serial signal to a parallel signal and supplies it to the data latch 507. The data latch 507 temporarily holds the input drive signal selection information and sends the drive signal selection information to the decoder 550 at the same time that the latch signal supplied to the data latch 507 rises.

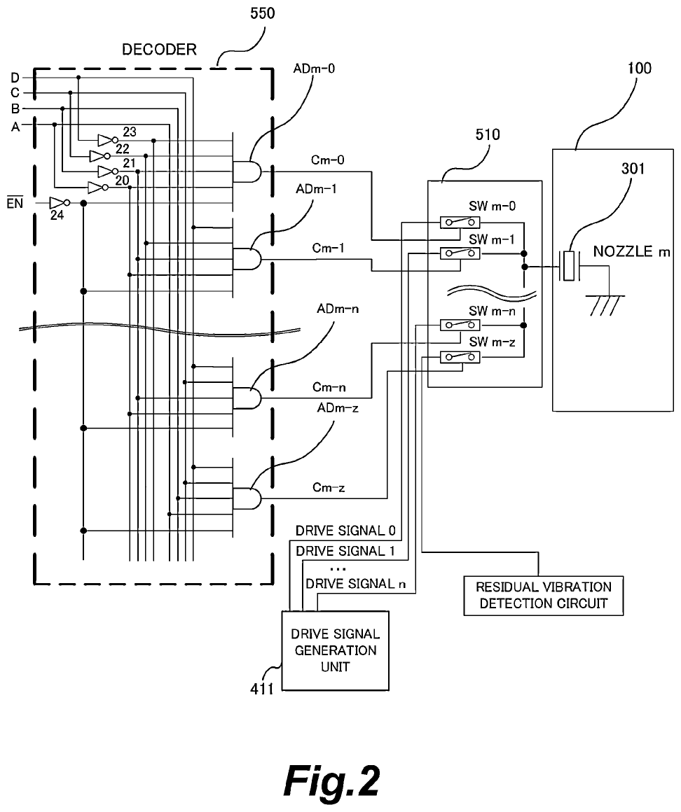

FIG. 2 illustrates an internal circuit of the decoder 550. In this embodiment, the drive signal selection information is input to the decoder 550 as 4-bit data, and is represented by a combination (A, B, C, D) of the signals of each bit input to input terminals A, B, C, and D of the decoder 550. The drive signal selection information (A, B, C, D) is information indicating which of the drive signals 0 to n output from the drive signal generation unit 411 will drive the piezoelectric element 301 of the head unit 100, and is determined based on the image data (drawing data). For example, suppose there are three types of drive signals: drive signal 0 (large ink droplet size), drive signal 1 (small ink droplet size), and drive signal 2 (no ink droplet ejection). In this case, the drive signal selection information (A, B, C, D) is, for example, (0, 0, 0, 0) corresponding to the drive signal 0, (0, 0, 0, 1) corresponding to the drive signal 1, or (0, 0, 1, 0) corresponding to the drive signal 2. For example, when the image data for a nozzle 0 is data to be drawn with a large ink droplet size, the drive signal selection information (A, B, C, D)=(0, 0, 0, 0) is input to the decoder 550 corresponding to a nozzle m. In FIG. 2, the decoder 550 corresponds to the nozzle m. m is the nozzle number, and in this embodiment, there are 128 nozzles, and the nozzle number takes a value of m=0 to 127. For example, in order to input the drive signal 0 to the piezoelectric element 301 of the nozzle m, the decoder 550 outputs switch control signals Cm-0 to Cm-z that turn on the switch SWm-0 and turn off the other switches SWm-1 to SWm-z.

The drive signal selection information (A, B, C, D) input to the decoder 550 is input to logical AND circuits ADm-1 to ADm-z provided at the output stage of the decoder 550, some of which go through inverter circuits 20 to 23, and the other part of which does not go through the inverter circuits 20 to 23. The switch control signals Cm-0 to Cm-z of the switches SWm-0 to SWm-z are output from the logical AND circuits ADm-0 to ADm-z. The logical AND circuit ADm-j that outputs the switch control signal Cm-j to the switch SWm-j corresponding to the drive signal j (j=1 to n) receives a signal as follows. That is, the signal corresponding to the bit with a value of 0 among the drive signal selection information (A, B, C, D) corresponding to the drive signal j is input through the inverter circuits 20 to 23. Furthermore, the signal corresponding to the bit with a value of 1 in the drive signal selection information (A, B, C, D) corresponding to the drive signal j is input without passing through the inverter circuits 20 to 23.

As described above, the latch signal is supplied as the EN signal to the EN signal input unit of the decoder 550. The EN signal is input to the logical AND circuits ADm-1 to ADm-z via the inverter circuit 24.

For example, signals are input to the logical AND circuit ADm-1, which outputs the switch control signal Cm-1 to the switch SWm-1 corresponding to the drive signal 1 (small ink droplet size), as follows. That is, signals A, B, and C corresponding to bits with a value of 0 in the drive signal selection information (A, B, C, D)=(0, 0, 0, 1) corresponding to the drive signal 1 are input to the logical AND circuit ADm-1 via the inverter circuits 20, 21, and 22. A signal D corresponding to a bit with a value of 1 is input directly to the logical AND circuit ADm-1 without passing through the inverter circuit.

In other words, when the drive signal selection information input to decoder 550 is (A, B, C, D), then (A′, B′, C′, D) is input to the logical AND circuit ADm-1. Here, “ ” indicates that the value has been converted by the inverter circuit.

Meanwhile, signals are input to another logical AND circuit, for example the logical AND circuit ADm-2 which outputs the switch control signal Cm-2 to the switch SWm-2 corresponding to the drive signal 2 (no ink droplet ejection), as follows. That is, signals A, B, and D corresponding to bits with a value of 0 in the drive signal selection information (A, B, C, D)=(0, 0, 1, 0) corresponding to the drive signal 2 are input to the logical AND circuit ADm-2 via the inverter circuits 20, 21, and 23. A signal C corresponding to a bit with a value of 1 is input directly to the logical AND circuit ADm-2 without passing through the inverter circuit.

That is, when the drive signal selection information input to the decoder 550 is (A, B, C, D), (A′, B′, C, D′) is input to the logical AND circuit ADm-2.

Hereinafter, the data (in the above example, (A′, B′, C′, D) or (A′, B′, C, D′)) that is input to the logical AND circuit after a part or all of the drive signal selection information is converted by the inverter circuit is referred to as a drive signal selection information conversion value.

For example, when the input image data is image data that indicates the ejection of a small ink droplet (drive signal 1) from the nozzle m, the drive signal selection information (A, B, C, D)=(0, 0, 0, 1) is input to the decoder 550 corresponding to the nozzle m. In this case, the drive signal selection information conversion value (A′, B′, C′, D)=(1, 1, 1, 1) is input to the logical AND circuit ADm-1. On the other hand, the drive signal selection information conversion value (A′, B′, C, D′)=(1, 1, 0, 0) is input to the logical AND circuit ADm-2.

Furthermore, when the input image data is image data that should result in no ink droplet ejection from the nozzle m (drive signal 2), the drive signal selection information (A, B, C, D)=(0, 0, 1, 0) is input to the decoder 550 corresponding to the nozzle m. Therefore, the drive signal selection information conversion value (A′, B′, C, D)=(1, 1, 0, 0) is input to the logical AND circuit ADm-1. On the other hand, the drive signal selection information conversion value (A′, B′, C, D′)=(1, 1, 1, 1) is input to the logical AND circuit ADm-2.

That is, in the decoder 550 configured as described above, the drive signal selection information conversion value input to the logical AND circuit corresponding to the switch corresponding to the drive signal corresponding to the drive signal selection information will be (1, 1, 1, 1). The drive signal selection information conversion value input to the logical AND circuits corresponding to the other switches includes 0. Therefore, the output of those logical AND circuits will be at the L level. Therefore, all signals other than the switch control signal of the switch corresponding to the drive signal corresponding to the drive signal selection information will be at the L level.

Furthermore, during a period when the latch signal input to the decoder 550 is at the H level, the EN signal with the H level is converted to the L level by the inverter circuit 24 and input to logical AND circuits ADm-0 to ADm-z. On the other hand, during a period when the latch signal input to the decoder 550 is at the L level, the EN signal with the L level is converted to the H level by the inverter circuit 24 and input to the logical AND circuits ADm-0 to ADm-z. Hereinafter, the EN signal converted by the inverter circuit 24 is referred to as an EN signal conversion value EN′.

That is, the drive signal selection information conversion value and the EN signal conversion value are input to the logical AND circuits ADm-0 to ADm-z. For example, when the drive signal selection information (A, B, C, D) determined based on the input image data is (0, 0, 0, 1), (A′, B′, C′, D, EN′)=(1, 1, 1, 1, 0) is input to the logical AND circuit ADm-1 during the period when the latch signal is at the H level. Therefore, the output of the logical AND circuit ADm-1 becomes the L level (logical value 0) by the logical AND operation. During the period when the latch signal is at the L level, (A′, B′, C′, D, EN′)=(1, 1, 1, 1, 1) is input. Therefore, the output of the logical AND circuit ADm-1 becomes the H level (logical value 1) by the logical AND operation. During the period when the latch signal is at the H level, (A′, B′, C, D′, EN′)=(1, 1, 0, 0, 0) is input to the logical AND circuit ADm-2. Therefore, the output of the logical AND circuit ADm-2 becomes the L level (logical value 0) as a result of the logical AND operation. During the period when the latch signal is at the L level, (A′, B′, C, D′, EN′)=(1, 1, 0, 0, 1) is input. Therefore, the output of the logical AND circuit ADm-2 becomes the L level (logical value 0) as a result of the logical AND operation.

In this way, when image data for driving the nozzle m is input by the drive signal 1, a switch control signal that turns on the switch is input only to the switch SWm-1 corresponding to the drive signal 1, and only while the latch signal is at the L level.

In addition, when the drive signal selection information (A, B, C, D)=(0, 0, 1, 0), (A′, B′, C′, D, EN′)=(1, 1, 0, 0, 0) is input to the logical AND circuit ADm-1 during the period when the latch signal is at the H level. Therefore, the output of the logical AND circuit ADm-1 becomes the L level (logical value 0) due to the logical AND operation. During the period when the latch signal is at the L level, (A′, B′, C′, D, EN′)=(1, 1, 0, 0, 1) is input. Therefore, the output of the logical AND circuit ADm-1 becomes the L level (logical value 0) due to the logical AND operation. During the period when the latch signal is at the H level, (A′, B′, C, D′, EN′)=(1, 1, 1, 1, 0) is input to the logical AND circuit ADm-2. Therefore, the output of the logical AND circuit ADm-2 becomes the L level (logical value 0) as a result of the logical AND operation. During the period where the latch signal is at the L level, (A′, B′, C, D′, EN′)=(1, 1, 1, 1, 1) is input. Therefore, the output of the logical AND circuit ADm-2 becomes the H level (logical value 1) as a result of the logical AND operation.

In this way, when image data for driving the nozzle m is input by the drive signal 2, a switch control signal that turns on the switch is input only to the switch SWm-2 corresponding to the drive signal 2, and only while the latch signal is at the L level.

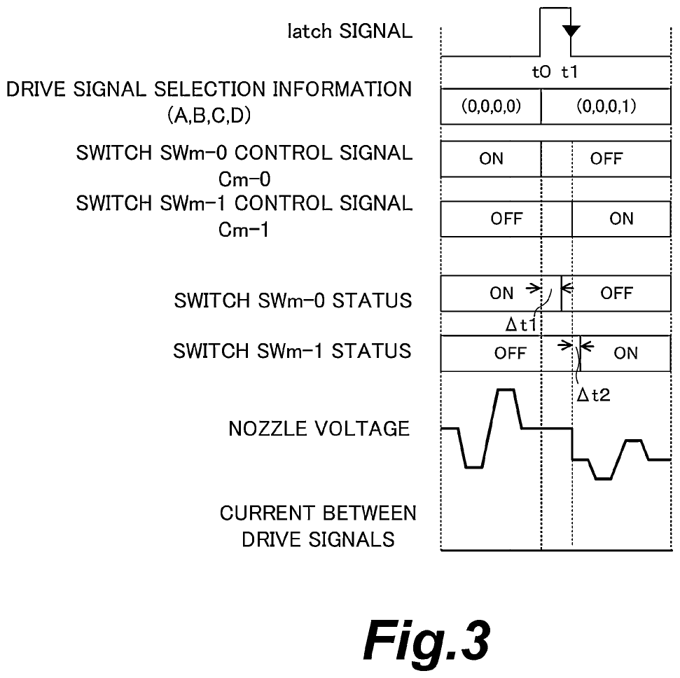

FIG. 3 illustrates an example of the latch signal and the operation of the switches SWm-0 and SWm-1. Here, the case is illustrated where image data for ejecting a large ink droplet size (drive signal 0) from the nozzle m is input, followed by image data for ejecting a small ink droplet size (drive signal 1) from the nozzle m. That is, this is a situation where a state where the switch SWm-0 to which the drive signal 0 is input is in an on state is switched from to a state where the switch SWm-1 to which the drive signal 1 is input becomes an on state. In the above configuration of the decoder 550, at the same time that the latch signal rises (time t0), the drive signal selection information (A, B, C, D)=(0, 0, 0, 1) corresponding to the drive signal 1 is sent to the decoder 550. This causes the signal levels of the input terminals of the logical AND circuits ADm-0 to ADm-z to switch appropriately. In this case, since the latch signal is at the H level, the output of the inverter circuit 24 becomes the L level, and the switch control signals Cm-0 to Cm-z output by the logical AND circuits ADm-0 to ADm-z all become the L level (OFF) (from time t0 to t1). In other words, the control signals of the switches SWm-0 and SWm-1 are the L level (OFF) during the period from time t0 to t1, regardless of the drive signal selection information (A, B, C, D).

Then, when the latch signal falls at time t1, only the output of the logical AND circuit ADm-1 of the decoder 550 becomes 1, and the switch control signal Cm-1 of the switch SWm-1 becomes the H level (ON) based on the drive signal selection information (A, B, C, D)=(0, 0, 0, 1). Here, a delay time from when the switch control signal Cm-0 (L level, OFF) for turning off the switch SWm-0 is input to the switch SWm-0 in the ON state at time to until the state of the switch SWm-0 actually becomes OFF is set to Δt1. The delay time Δt1 is shorter than a predetermined period (t0 to t1) during which the latch signal becomes the H level. Therefore, it is possible to prevent both switches from being simultaneously ON during the period (t0 to t1) including the switching timing of the switch control signal.

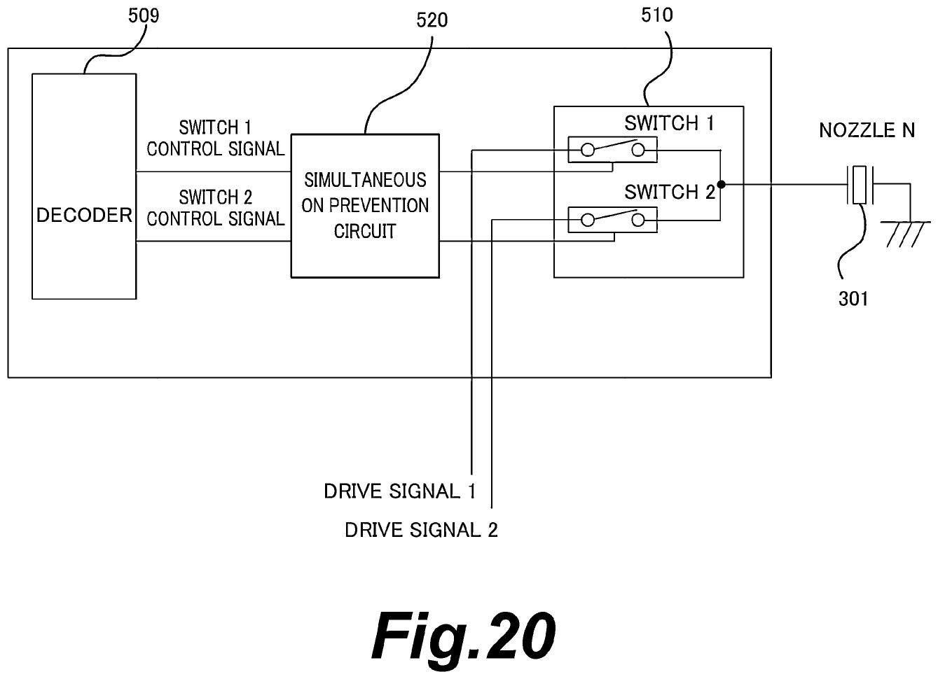

In this embodiment, the switch control signal (Cm-0, Cm-1 in FIG. 3) itself output from the decoder 550 is at the L level (OFF) during the period when the latch signal is at the H level (t0 to t1 in FIG. 3) regardless of the drive signal selection information ((A, B, C, D) in FIG. 3). Specifically, the switch control signal (Cm-0, Cm-1 in FIG. 3) is at the L level during a predetermined period ((A, B, C, D) in FIG. 3) including the switching timing of the drive signal selection information ((A, B, C, D) in FIG. 3) specified by the timing signal (latch signal in FIG. 3). Therefore, even when the switch control signal output from the decoder 550 is directly input to the switch group 510, it is possible to prevent the simultaneous ON state when the drive signal is switched. Therefore, since there is no need to place a simultaneous ON prevention circuit as illustrated in FIG. 20 in a stage before inputting the switch control signal output from the decoder 550 to the switch group 510, a simple circuit configuration can be achieved. According to this embodiment, therefore, it is possible to prevent the analog switches from being turned on simultaneously with a simple configuration, and to prevent malfunctions and failures of the recording device.

In this embodiment, the drive signal generation unit 411, which has drive signal generation circuits 0 to n, outputs drive signals 0 to n to drive the piezoelectric element 301. The drive signals 0 to n are signals that correspond to the size of the droplets of liquid ejected from the nozzles of the ejection head. The drive signals 0 to n are also signals that correspond to whether liquid is ejected from the nozzles of the ejection head. In the above example, the drive signal 0 is a signal that corresponds to a large droplet size, the drive signal 1 is a signal that corresponds to a small droplet size, and the rive signal 2 is a signal that corresponds to no droplet ejection.

When any of the drive signals 0 to n, for example the drive signal 0, is set to a first drive signal, then the drive signal generation circuit 0 that outputs the drive signal 0 is set to a first output unit. Furthermore, when the drive signal 1 is set to a second drive signal, then the drive signal generation circuit 1 that outputs the drive signal 1 is set to a second output unit.

The switch group 510 is switch means capable of switching on or off the input of the drive signals 0 to n output from the drive signal generation unit 411 to the piezoelectric element 301. The switch group 510 is provided for each nozzle (each piezoelectric element 301), and each switch group 510 is provided with switches SWm-0 to SWm-n for each drive signal. Here, when there are 128 nozzles and three types of drive signals, then m=0 to 127 and n=2.

For example, when the drive signal 0 is set to a first drive signal, then a switch SWm-0 (m=0 to 127) that switches the input of the drive signal 0 to the piezoelectric element 301 is a first switch. Furthermore, when the drive signal 1 is set to a second drive signal, then a switch SWm-1 (m=0 to 127) that switches the input of the drive signal 1 to the piezoelectric element 301 is a second switch. Furthermore, a switch SWm-z connected to a residual vibration detection circuit is included in each switch group 510.

The drive signal selection information is selection information generated by the recording control unit 407 based on image data, and indicates which of the drive signals 0 to n is to be input to the piezoelectric element 301. The drive signal selection information transmission unit 409 is a selection output unit for outputting this drive signal selection information to the drive signal selection unit 412.

The decoder 550 is a control output unit for outputting a switch control signal to each switch SWm-0 to SWm-z based on the drive signal selection information input from the drive signal selection information transmission unit 409 and a timing signal that specifies the timing of switching the selection information. The decoder 550 is provided for each nozzle (for each piezoelectric element 301). The mth decoder 550 outputs switch control signals Cm-0 to Cm-z that control the on/off of the switches SWm-0 to SWm-z connected to the mth nozzle m.

The switch control signals Cm-0 to Cm-z are signals that control the on and off of the switches SWm-0 to SWm-z, and the on or off state of the switches SWm-0 to SWm-z is switched according to the input switch control signals Cm-0 to Cm-z.

In this embodiment, the timing signal is a latch signal. As illustrated in FIG. 3, the latch signal is a pulse signal that changes from a first level (L level, logical value 0) to a second level (H level, logical value 1) different from the first level at a leading edge (time t0) and changes from the second level to the first level at a trailing edge (time t1).

In the switch control signals Cm-0 to Cm-z, the control signals for turning the SWm-0 to SWm-z off are signals of a first level (L level, logical value 0), and the control signals for turning them on are signals of a second level (H level, logical value 1).

The drive signal selection information transmission unit 409 outputs a signal that becomes the second level (H level, logical value 1) as the drive signal selection information when the drive signals 0 to n are input to the piezoelectric element 301. For example, when the drive signal 0 is set to the first drive signal, the drive signal selection information transmission unit 409 outputs a first selection signal that becomes the second level (H level, logical value 1) when the drive signal 0 is input to the piezoelectric element 301 ((A, B, C, D)=(0, 0, 0, 0) described below). Also, when the drive signal 1 is set to the second drive signal, the drive signal selection information transmission unit 409 outputs a second selection signal that becomes the second level (H level, logical value 1) when the drive signal 1 is input to the piezoelectric element 301 ((A, B, C, D)=(0, 0, 0, 1) described below).

This embodiment is characterized by the configuration of the decoder 550. That is, the switch control signals Cm-0 to Cm-z output by the decoder 550 are at the L level (logical value 0) during a predetermined period including the drive information switching timing specified by the latch signal, which is a timing signal. That is, during the predetermined period, the switch control signals Cm-0 to Cm-z are control signals for turning off SWm-0 to SWm-z. The predetermined period includes the period from the timing of the leading edge of the latch signal (time to in FIG. 3) to the timing of the trailing edge of the latch signal (time t1 in FIG. 3).

The predetermined period (t0 to t1) is longer than the delay time from when a control signals (L level, logical value 0) for turning off the SWm-0 to SWm-z are input to the SWm-0 to SWm-z in the on state until the SWm-0 to SWm-z are turned off.

The logical AND circuits ADm-0 to ADm-z are logical AND circuits that always output first level signals when there is a first level (L level, logical value 0) signal among the plurality of input signals. For example, when the drive signal 0 is set to the first drive signal, the logical AND circuit ADm-0 is a first logical AND circuit to which a signal obtained by inverting the first selection signal (for example, (A, B, C, D)=(0, 0, 0, 0)) and the timing signal (latch signal) is input. Further, the output signal of the logical AND circuit ADm-0, which is the first logical AND circuit, becomes a switch control signal Cm-0 that is output to first switch SWm-0. In addition, when the drive signal 1 is set to a second drive signal, the logical AND circuit ADm-1 is a second logical AND circuit to which a signal obtained by inverting the second selection signal (for example, (A, B, C, D)=(0, 0, 0, 1)) and the timing signal (latch signal) is input. Further, an output signal of the logical AND circuit ADm-1, which is the second logical AND circuit, becomes a switch control signal Cm-1 that is output to first switch SWm-1.

According to the present disclosure, in a recording device that uses a piezoelectric element to eject liquid, a simple configuration can be used to prevent a plurality of analog switches that switch the drive signals input to the piezoelectric elements from being turned on simultaneously.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-203909, filed on Dec. 1, 2023, which is hereby incorporated by reference herein in its entirety.

What is claimed is:

1. A recording device including a piezoelectric element and a recording head ejecting liquid by driving the piezoelectric element, the recording device performing recording by the liquid ejected by the recording head,
the recording device comprising:
a first output unit outputting a first drive signal for driving the piezoelectric element;
a second output unit outputting a second drive signal for driving the piezoelectric element;
a first switch switching on or off input of the first drive signal output from the first output unit to the piezoelectric element;
a second switch switching on or off input of the second drive signal output from the second output unit to the piezoelectric element;
a selection output unit outputting selection information indicating which of the first drive signal and the second drive signal is to be input to the piezoelectric element based on image data; and
a control output unit outputting to the first switch and the second switch a switch control signal for controlling on and off of the first switch and the second switch based on the selection information input from the selection output unit and a timing signal defining a switching timing of the selection information, wherein
the switch control signal output by the control output unit is a control signal for turning off the first switch and the second switch during a predetermined period including the switching timing defined by the timing signal.

2. The recording device according to claim 1, wherein
the timing signal is a pulse signal, and
the predetermined period includes a period from a timing of a leading edge of the pulse signal to a timing of a trailing edge of the pulse signal.

3. The recording device according to claim 1, wherein
the timing signal is a pulse signal that changes from a first level (L) to a second level (H) different from the first level at a leading edge and changes from the second level to the first level at a trailing edge,
in the switch control signal,
a control signal for turning off the first switch and the second switch is a signal of the first level, and
a control signal for turning on the first switch and the second switch is a signal of the second level,
the control output unit includes,
a first logical AND circuit outputting a signal of the first level whenever a signal of the first level is present among a plurality of input signals, and
a second logical AND circuit outputting a signal of the first level whenever a signal of the first level is present among a plurality of input signals,
a signal obtained by inverting the timing signal is input to the first logical AND circuit and the second logical AND circuit, and
the control output unit outputs,
an output signal of the first logical AND circuit to the first switch, and
an output signal of the second logical AND circuit to the second switch.

4. The recording device according to claim 3, wherein
the selection output unit outputs, as the selection information,
a first selection signal that is at the second level when the first drive signal is input to the piezoelectric element, and
a second selection signal that is at the second level when the second drive signal is input to the piezoelectric element, and
in the control output unit,
the first selection signal and the signal obtained by inverting the timing signal is input to the first logical AND circuit, and
the second selection signal and the signal obtained by inverting the timing signal is input to the second logical AND circuit.

5. The recording device according to claim 1, wherein
the first drive signal and the second drive signal are signals in accordance with a size of a droplet of the liquid ejected from the recording head.

6. The recording device according to claim 1, wherein
the first drive signal and the second drive signal are signals in accordance with whether the liquid is to be ejected from the recording head.

7. The recording device according to claim 1, wherein
the predetermined period is longer than a delay time from a timing when a switch control signal for turning off the first switch is input to the first switch in an on state until a timing when the first switch enters an off state.

8. The recording device according to claim 1, wherein
the predetermined period is longer than a delay time from a timing when a switch control signal for turning off the second switch is input to the second switch in an on state until a timing when the second switch enters an off state.
